(19) United States
(12) Patent Application Publication
(10) Pub. No.: US 2023/0065232 A1
(43) Pub. Date: Mar. 2, 2023

(54) METHOD FOR DECONTAMINATION AND STERILIZATION OF FOOD

(71) Applicant: Gyrotron Technology, Bensalem, PA (US)

(72) Inventors: Vladislav SKLYAREVICH, Bensalem, PA (US); Mykhaylo SHEVELEV, Huntingdon Valley, PA (US)

(73) Assignee: Gyrotron Technology, Bensalem, PA (US)

(21) Appl. No.: 17/412,939

(22) Filed: Aug. 26, 2021

(51) Int. Cl. A23L 3/01; A23B 4/01; A22C 21/00

(52) U.S. Cl. CPC A23L 3/01; A23B 4/012; A22C 21/0061; A23V 2002/00

(57) ABSTRACT

A method for microbiological decontamination/sterilization of an organic product is described. In this method, an organic product is provided with a liquid or liquefiable material layer on its surface. The liquid or liquefiable material is removed by explosive vaporization by irradiating the layer with a gyrotron microwave beam having a power density of at least about 500 W per square cm. The beam frequency is selected to be approximately equal to the liquid or liquefiable material layer thickness, and the irradiation time is about 0.5 second or less.

### FIELD

The method disclosed herein relates generally to the microbiological decontamination of food. More specifically, the method relates to decontamination of meat and poultry, including during meat and poultry packing, packaging, and/or preparation for sale, without affecting the marketable condition. The method as disclosed herein also is applicable to the decontamination of other food products, including seafood, fruits, vegetables, and similar food products that are solid and/or semisolid.

### BACKGROUND

The CDC estimates that 48 million people get sick, 128,000 are hospitalized, and 3,000 die, from foodborne diseases each year in the United States. The estimated healthcare cost is $152 billion annually (Scallan et al., 2011; Scharf et al., 2010). Vegetative foodborne pathogens responsible for foodborne illness include microorganisms such as pathogenic Escherichia coli (STEC and ETEC) as well as Salmonella spp., Listeria monocytogenes, Staphylococcus aureus, Campylobacter, and Yersinia spp. Pathogenic bacteria such as pathogenic E. coli and Salmonella are present in cattle feed lots and holding pens, and are present on the hides of the animals (Brichta-Harhay et al., 2011; Arthur et al. 2011, 2010). These pathogenic bacteria, when present in cattle, can contaminate beef carcasses due to cross contamination between the hides and the gastrointestinal tract, and the processed carcass during the slaughter process. Ground meat products, poultry, vegetables, and fruits also can be contaminated and lead to illnesses, hospitalizations, and deaths.

Traditional methods for decontamination of food (raw meat, carcass surfaces, fruits, vegetables, etc.) involve the use of conventional heating processes by hot water and air, see for example, U.S. Pat. Nos. 4,337,549, 5,470,597, 5,607,349, 6,291,003, 7,108,882, 10,472,837; steam, see U.S. Pat. Nos. 5,607,349, and 6,291,003; organic acids, see U.S. Pat. Nos. 3,122,417, 3,248,281, 5,234,703, 6,183,807, 6,964,787, and 8,043,650; or a combination of heat, water, and organic acids, see U.S. Pat. No. 3,401,044.

Different kinds of irradiation of food products also have been used. For example, a low energy electron beam, ultraviolet, gamma rays from radioisotopes, X-rays generated by energetic electron bombardment on hard metal targets, direct bombardment with energetic electrons, as well as, conventional microwave. For example, see U.S. Pat. Nos. 5,400,382, 4,983,411, 5,603,972, and 7,588,486, and U.S. Patent Publication No. 2018/0007922.

The main problems in using these methods are low productivity and low efficiency and creating an undesirable end product. The heat treatment often results in “cooking” the products, changing the desirable color and texture, thereby making the treated product unacceptable.

Research has shown that for decontamination, for example, meat must be heated at 70° C.-100° C. for dozens of seconds and even minutes to achieve a safe product with an acceptable contamination level. Such a decontamination time is too long for an average meat processing plant with, for example, over 3,000 carcasses to be cleaned daily. In addition, the appearance of the meat is not acceptable after such a decontamination process. At the same time high quality, minimally processed foods with fresh appearances and little to no additives are desired and demanded. Furthermore, all these methods provide, in the best case, only around a 95% level of decontamination. The remaining 5% of pathogens multiply back very quickly reducing shelf life and making the product dangerous again. Consequently, such decontamination is virtually worthless. As such, these approaches are expensive, not productive and most of them environmentally unfriendly.

There is a clear need in the art for a more effective, productive, and environmentally secure method for surface decontamination, especially with regard to foods.

### SUMMARY

The present method is directed to the decontamination/sterilization of sold and semisold organic products. These organic products can be foods. These foods include meat, poultry, seafood, produce, dairy products, and mixtures thereof. The meat, poultry, and seafood can be full carcasses of the animals or pieces thereof. The meat, poultry, and seafood can be raw or partially cooked, or fully cooked, as in deli meats. The foods can be treated unwrapped from any type of packaging or packaged in material having an absorption of the gyrotron microwave beam lower than the liquid layer on the product surface. Packaged foods include packaged raw meats, packaged deli meats, and the like.

The method for decontamination/sterilization of solid and semisolid organic products comprises a) providing a product having a liquid or liquefiable layer on the product surface; b) irradiating at least a portion of the product surface with a gyrotron microwave beam having a power density of at least about 500 W per square cm, with the frequency of the beam selected to be sufficient for the beam penetration depth to be approximately equal to or less than the liquid or liquefiable material layer thickness, and with an irradiation time of no more than about 0.5 second; and c) removing the liquid or liquefiable layer on the product surface by explosive vaporization during the irradiating step. During the irradiating step, the liquid or liquefiable layer on the product surface is removed by explosive vaporization. This explosive vaporization provides for the product's decontamination/sterilization. In the methods as disclosed herein, greater than 99% of bacteria, viruses, and parasites on the surface of the product may be killed or eliminated.

It has been discovered that by using a gyrotron microwave beam, selecting a frequency such that the beam penetration depth in the liquid or liquifiable layer is approximately equal to or at least shorter than the liquid or liquefiable layer thickness, together with limiting the irradiation time to about 0.5 second or less, minimal impact on the product marketable conditions occurs while providing effective decontamination.

In certain embodiments, the microwave beam frequency is in the range of about 40 GHz to about 200 GHz. In specific embodiments, the irradiation time is about 0.5 seconds to 0.01 seconds. In further embodiments, the power density is about 500 W per square cm to about 5000 W per square cm. In particular embodiments, the microwave beam frequency is in the range of about 40 GHz to about 200 GHz; the irradiation time is about 0.5 seconds to 0.01 seconds; and the power density is about 500 W per square cm to about 5000 W per square cm.

In the methods disclosed herein, greater than 99% of the microbes, bacteria, viruses, parasites, and other pathogens, on the surface of the product are killed or eliminated to achieve a safe product with an acceptable contamination level.

### BRIEF DESCRIPTION OF THE DRAWINGS

FIG. 1 schematically illustrates the irradiation of a product.

FIG. 2 is a graph showing the dependency of gyrotron microwave beam penetration depth (y-axis) in water relative to frequency (x-axis), as well as real depth range for the gyrotron beam.

FIG. 3 illustrates an embodiment of continuous processing a meat product and irradiating the entire surface of the meat product

### DETAILED DESCRIPTION

Before the methods for decontamination are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a treatment should not be taken to be all of the products of the treatment, and reference to “treating” may include reference to one or more of such treatment steps. As such, the step of treating can include multiple or repeated treatments.

The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

Numerical values with “about” or “approximately” include typical experimental variances. As used herein, the term “about” means within a statistically meaningful range of a value, such as a stated power density, frequency, time, depth, or temperature. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” and “approximately” will depend upon the particular value under study, and can be readily appreciated by one of ordinary skills in the art. Whenever a range is recited within this application, every whole number integer within the range is also contemplated as an embodiment.

Disclosed herein are methods for decontamination/sterilization of solid and semisolid organic products. These organic products include food.

As used herein, “food” includes meat, poultry, seafood, produce (fruits and vegetables), and dairy products (e.g., cheese), as long as these products are solid or semisolid at room temperature.

“Meat” is the flesh og a mammal, for example beef, pork, venison, bison, elk, and the like.

“Animal carcasses” refer to the animal as a whole or in any substantial part.

“Poultry” is the flesh of a bird, for example, turkey, chicken, quail, duck, and the like.

“Seafood” includes the flesh of any animal originating from water. As such, it includes the flesh of bony fishes (such as tuna, salmon, bass, and the like) and more primitive fish (such as sharks, and the like), crustaceans (such as lobsters, crabs, shrimps, and the like), mollusks (such as clams, oysters, mussels, scallops, and the like).

As such, the foods to be treated by the methods disclosed herein include meat, poultry, seafood, produce, dairy products, and mixtures thereof. The meat, poultry, and seafood can be full carcasses of the animals or pieces/cuts thereof. The meat, poultry, and seafood can be raw or partially cooked or fully cooked. Fully cooked include deli meats and poultry, including ham, bacon, sliced turkey, sliced beef, salami, prosciutto, hot dogs, and the like. The foods can be treated unwrapped and free of any type of packaging or packaged in material having an absorption of the gyrotron microwave beam lower than the liquid layer on the product surface.

Produce to be treated includes fruits and vegetables. For example, the vegetables can be leafy greens. In certain embodiments, the vegetables can be spinach, celery, cabbage, lettuce, cucumbers, and the like. In certain embodiments, the fruits can be apples, oranges, mangos, tomatoes, melons, berries (e.g., strawberries, raspberries, blackberries, and blueberries), and the like.

As used herein “decontamination” and “sterilization” are used interchangeably and these terms mean that greater than 99% of the microbes, bacteria, viruses, parasites, and other pathogens, on the surface of the product are killed or eliminated to achieve a safe product with an acceptable contamination level. In certain embodiments greater than 99.9% are killed; in particular embodiments, greater than 99.95% are killed, and in particularly preferred embodiments greater than 99.99% are killed. The level of decontamination/sterilization distinguishes the methods disclosed herein from known techniques and provides clear advantages to these disclosed methods.

As such, the present method is applicable to decontamination/sterilization of all types of foods that are solid or semisolid at room temperature (i.e, not liquid at room temperature).

The decontamination/sterilization of these solid and semisolid food products is achieved by the method as disclosed and described herein. The food products treated in the present method can be solid organic products such as animal carcasses, pieces of raw or cooked meat, poultry, or fish, solid or semisolid cheeses, fruits, and vegetables, or any combination thereof. In certain embodiments, the organic products are selected from the group consisting of meat, poultry, seafood, produce, dairy products, and mixtures thereof.

The method for decontamination/sterilization as disclosed herein includes a) providing a product having a liquid or liquefiable material layer on the product surface; b) irradiating at least a portion of the product surface with a gyrotron microwave beam having a power density of at least about 500 W per square cm, with the frequency of the beam selected to be sufficient for the beam penetration depth in the liquid or liquefiable material to be of approximately equal to or less than the liquid or liquefiable material layer thickness, and with the irradiation time being no more than about 0.5 second; and c) removing the liquid or liquefiable layer on the product surface by explosive vaporization during the irradiating step. During the irradiating step, the liquid or liquefiable layer on the product surface is removed by explosive vaporization. In certain embodiments, the method comprises irradiating the entire product surface with a gyrotron microwave beam. The liquid or liquefiable layer on the product surface is removed by explosive vaporization during the irradiating step, which provides for the decontamination/sterilization of the organic product.

As such, the methods as disclosed herein may remove, eliminate, or kill greater than 99% of the microbes, bacteria, viruses, parasites, and other pathogens, on the surface of the product to achieve a safe product with an acceptable contamination level. In certain embodiments greater than 99.9% are killed; in particular embodiments, greater than 99.95% are killed, and in particularly preferred embodiments greater than 99.99% are killed.

In certain embodiments, the gyrotron microwave beam frequency is about 40 GHz to about 200 GHz. In specific embodiments, the irradiation time is about 0.5 seconds to 0.01 seconds. In further embodiments, the power density is about 500 W per square cm to about 5000 W per square cm. In particular embodiments, the gyrotron microwave beam frequency is about 40 GHz to about 200 GHz; the irradiation time is about 0.5 seconds to 0.01 seconds; and the power density is about 500 W per square cm to about 5000 W per square cm. In other embodiments, the gyrotron microwave beam frequency is about 40 GHz to about 100 GHz; the irradiation time is about 0.5 seconds to 0.01 seconds; and the power density is about 500 W per square cm to about 5000 W per square cm.

In certain embodiments, the product has a naturally existing liquid or liquefiable material on its product surface. In other embodiments, the method further comprises applying a liquid or liquefiable layer to the product surface to provide the product having a liquid or liquefiable layer on the product surface. In certain of these embodiments (both with applied and naturally existing liquid or liquefiable material on the product surface), the method further comprises applying liquid or liquefiable material to the product surface after irradiation.

As such, the present method involves irradiating at least a portion of the surface of a product, these products being described above. This product has a liquid or liquefiable layer on its surface. This layer can be comprised of pure or salted water, oil, blood, fat, wax, sap, and the like, or any combination thereof. A liquid is a material in liquid form at room temperature. As used herein room temperature is about 15 to 25° C. (59 to 77° F.). Liquids suitable for use herein include water, salted water, oil, blood, saps, and the like, or combinations thereof. In certain embodiments, the liquid is water, salted water, oil, blood, or a combination thereof. A liquefiable material is a material not in liquid form at room temperature, but upon heating becomes a liquid. Liquefiable materials suitable for use herein include fats, waxes, and the like. In certain embodiments, the liquefiable material is fat, wax, sap, or a combination thereof.

The layer can be present naturally on the product to be treated or may be added to the product prior to treatment. In addition, additional liquid or liquefiable material may be added to a naturally existing layer on the product surface. For example, naturally existing liquid or liquefiable substances on the product surface generally include moisture, blood, fat, sap, and the like.

The present method involves selecting a set of processing parameters, including gyrotron beam frequency, power density and time of the irradiation, to provide an explosive vaporization of the liquid or liquefiable layer that achieves a high enough temperature in a suitable short time to effect decontamination of the product. Importantly, this also prevents product cooking, product decomposition, and other structural damage to the product that would damage the marketable condition of the product. For raw meats, poultry, and produce, it is important that the raw nature of the product not be disrupted during decontamination. It is the selection of these parameters to achieve the explosive vaporization of the liquid or liquefiable layer without damage to the product surface that provides the benefits.

In the present method, the beam wavelength/frequency is selected such that the beam penetration depth in the liquid or liquefiable material is approximately equal to, or less than, the thickness of the liquid or liquefiable material layer. The penetration depth needs to be sufficient to achieve the explosive vaporization of the liquid or liquefiable layer but without damage to the product. In some embodiments, it is preferred that the penetration depth is approximately equal to the layer thickness.

The selected frequency is generally in the range of about 40 GHz to about 200 GHz. In certain embodiments, the selected frequency can be in the range of about 40 GHz to about 100 GHz. It has been discovered that when the frequency is selected so that the penetration depth approximates the layer thickness, the layer is screening the incident microwave from further penetration of microwave energy into the product. While effecting decontamination, it also prevents a negative impact on the product, such as a change in color or texture.

In combination with the selection of the wavelength/frequency, the gyrotron microwave beam used has a power density of at least about 500 W per square cm, and generally the power density is higher than 500 W per square cm. In some embodiments, the power density is in the range of about 500 W/cm² to about 5000 W/cm². In one particular embodiment, the power density is about 1000 W/cm². Any of these embodiments of frequency can be utilized with any of the embodiments of the selected frequency as set forth above.

The beam utilized in the present methods is generated by a gyrotron. Specifically, the gyrotron provides the type of beam that provides explosive vaporization of the liquid or liquefiable surface layer in such a short time that minimal impact, if any, on the characteristics of the product are observed.

Due to the power of the gyrotron microwave beam, the time of the irradiation is controlled to no more than about 0.5 second, and in some embodiments can be much less. In one embodiment, the radiation time is in the range of about 0.5 second to about 0.01 second. In another embodiment, the radiation time is about 0.1 second. Any of these embodiments of time for irradiation can be utilized with any of the embodiments of frequency and power density as set forth above.

The short time for irradiation is particularly important when irradiating organic products to avoid any Maillard reactions, as these Maillard reactions damage the marketable condition of the product. In certain embodiments, the irradiation time is less than about 100 milliseconds and the power density of the beam is selected such that it prevents Maillard reaction of the organic product.

In one embodiment, the irradiation beam is focused by optics to the shape of the product configuration or scanning the beam over the product. The optics can comprise various reflectors to ensure that the beam covers the peculiar shape of the product. The reflectors can be controlled by computer. One of skill in the art for operation of a gyrotron can readily operate accordingly.

In another embodiment, the product is placed on a transporter that creates a flow or movement of the product and sufficiently changes the product's spatial orientation with respect to the beam to provide irradiation of the entire surface of the product. The transporter can be a conveyer, for example, a chain conveyor from which the product hangs or a belt. On a chain conveyor the product can be rotated while hanging. This rotation can aid in irradiating the entire surface of the product. As used herein, the entire surface means the entirety of the outside surface of the product to be treated.

In one embodiment, the product is irradiated by the gyrotron microwave beam more than once to further increase the decontamination level. For example, the irradiation can occur 2, 3, or 4 times. Irradiation multiple times can be preferable to achieve and ensure the proper level of decontamination. This is particularly used when the product is of a peculiar shape, e.g., of an animal carcass or poultry. In the multiple irradiations, an additional liquid or liquefiable material layer can be applied more than once, as well, for example before each additional irradiation, after the previous irradiation is completed.

In an additional embodiment of the present method, the product to be treated can be a packaged food product. As such, the organic products are packaged in material having an absorption of the gyrotron microwave beam lower than the liquid layer on the product surface. In these embodiments, the packaged food product is decontaminated by irradiating it through its packaging film. This packaging film is selected to have an absorption of the beam lower than the liquid or liquefiable material layer of the product. Examples of appropriate packaging films include polypropylene, polyethylene, polyester, and the like.

In one embodiment, the product to be treated is poultry and the surface to be decontaminated is its skin. To kill microbes, viruses, parasites and other pathogens on the skin, including in hidden holes from a lost feather, the beam power density and irradiation time are selected to heat the entire skin to a temperature that is sufficient for microbial inactivation.

In another embodiment, the product to be treated is fruits, vegetables, or rice.

In another embodiment, the product to be treated is a hard cheese or a soft cheese.

In another embodiment of the present method, additional liquid or liquefiable material is applied to the product after irradiation. This approach helps to prevent the degradation of an organic product surface by cooling it after the irradiation.

In an another embodiment, an organic product may be preheated before the irradiation with the gyrotron microwave beam. The preheating is to a temperature that does not exceed the temperature of protein denaturation of the organic product. The preheating can be achieved by traditional heat sources such as heat lamps or convention heat sources. This preheating reduces the time required for radiation with the gyrotron microwave bean at a power density of over about 500 W per square cm. In another embodiment, the preheating is conducted by a gyrotron microwave beam before the vaporizing. In another embodiment, an additional convection heat source, can be used to preheat the product. The additional convection heat source can be selected from combustible gases, combustible fluids, hot air, or combinations thereof. Preheating can be combined with any of the embodiments as described herein.

In another embodiment, the irradiation time is selected to be less than about 100 milliseconds and the corresponding power density of the beam is selected such that it avoids a Maillard reaction in organic products.

In one embodiment, the selected surface to be irradiated is an entire product surface.

The method can include continuous in-line decontamination of solid and semisolid products that comprises a microwave shielded chamber with an attached gyrotron. The method can include a conveyor capable of changing the spatial orientation of each individual product and a microwave applicator capable of re-forming and directing the beam to a selected area of the product surface. In one embodiment, the chamber has a sprayer or applicator for applying the liquid or liquefiable layer on product surfaces, as well as an applicator with one or more metal reflectors capable of changing the beam shape. Thus, the method can further include spraying or applying the liquid or liquifiable material to the product surface prior to irradiation and/or after irradiation.

Certain exemplary embodiments of the present method will now be described in greater detail with reference to the accompanying drawings. Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

As provided for herein, a method for microbiological decontamination/sterilization of solid and semisolid organic products is disclosed. A liquid or liquefiable material, such as water, oil, wax, fat, blood, and the like (1, see FIG. 1) is provided as a layer on the surface of a product (2) in at least one selected surface area of the product. Then an explosive vaporizing of the liquid or liquefiable layer from the at least one selected surface area of the product is achieved by irradiating the liquid or liquefiable material (1) by a gyrotron microwave beam (3).

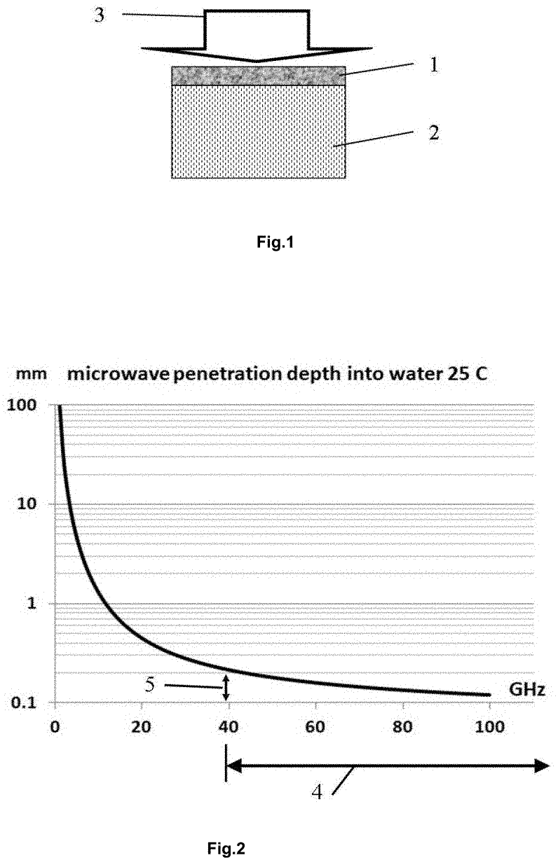

Liquid materials in general, are good absorbers of microwaves and the penetration of the radiation depends, first of all, on the microwave frequency. In the present method, the gyrotron microwave beam with frequencies about 40 GHz to about 200 GHz (4, see FIG. 2) and with a power density of at least about 500 W per square cm is applied to the product surfaces. The penetration of the microwave into the layer is a fraction of a millimeter (5, see FIG. 2).

The beam power density of about 500 W per square cm and greater, is found to provide sufficient explosive vaporization of the liquid or liquefiable material layer in less than about 0.5 sec. Such power density is possible for the gyrotron, which is readily available providing hundreds of kW of power and it can irradiate a concentrated microwave in continuous and pulse modes. Continuous and pulse modes both are useful in the methods as described herein.

The vaporization of the liquid or liquefiable layer allows one to heat the liquid or liquefiable material (and corresponding contaminated product surface) to a temperature greater than the normal boiling point of water (i.e., over ° C.). Analyses of existing data and publications (see, for example, Thermal Inactivation of Salmonella senftenberg and Listeria innocua in Ground Chicken Breast Patties Processed in an Air Convection Oven R. Y. Murphy, 1 E. R. Johnson, B. P. Marks, M. G. Johnson, and J. A. Marcy *Department of Biological and Agricultural Engineering and †Department of Food Science, and Department of Poultry Science, University of Arkansas, Fayetteville, Ark. 72701) show that using temperatures over 100° C., a high level of decontamination can be achieved in short time. However, with traditional techniques this could not be achieved without damaging the product (e.g., causing protein degradation). In the present method, the irradiation time is less than about 0.5 seconds, and advantageously, the product is treated such that no or minimal damage is caused (i.e., protein degradation).

As described above, the major part of gyrotron microwave energy, at about 40 GHz-200 GHz, is absorbed by the liquid or liquefiable layer, and only a minor part of the microwave energy potentially penetrates through the liquid or liquefiable layer. The amount that may penetrate is so small that it does not change performance and quality of the treated product. This along with a short irradiation time leads to a vanishingly minimal impact of the heat on product's marketable conditions.

In one embodiment, irradiation occurs more than once (for example 2 or 3 times) to further increase the decontamination level. This approach may be advantageous in the case of products with complicated shapes (e.g., poultry, animal carcasses, and the like). The liquid or liquefiable material layer can be applied on the product surface more than once, as well. For example, a liquid or liquefiable layer can be applied before each irradiation. Further, in certain embodiments a liquid or liquefiable layer can be applied after the final irradiation.

In another embodiment, the selected surface is the entire product surface. To achieve this the spatial orientation of the product with respect to the beam changes and/or the beam is directed over the product by an electrodynamics means.

In some embodiments of the present method, the beam is re-focused by optics to cover the shape of the product configuration. A product can also be placed on a transporter, such as a conveyor, that creates a flow or movement of the product to change the spatial orientation of the product with respect to a beam and thereby provide irradiation of the entirety of the outside surface of the product. This can aid in irradiating the entire product surface when the product has a complex shape. Products with complex shapes include carcasses and poultry skin. As such, the methods disclosed herein may further comprise placing the product on a transporter that moves the product to change the spatial orientation of the product with respect to the beam to provide irradiation of the entire surface of the product.

Unpackaged or packaged food products as described herein can be decontaminated by the present method. The packaging material, for example, a plastic film, is selected with absorption properties of the beam lower than the liquid layer. The liquid or liquefiable layer is applied before packaging or is retained if it is naturally present on the product.

In some aspects, naturally existing liquid or liquefiable materials on the product surface such as moisture, sap, blood, fat, and the like, can be used.

In another embodiment, the product can be preheated before the irradiating with the gyrotron to explosively vaporize the liquid or liquifiable layer. The preheating is to the temperature not exceeding a temperature that would cause organic product protein denaturation. This reduces the radiation time that is necessary to reach the explosive vaporization (pathogen killing temperature), and makes it easier to keep the decontaminated organic products, for example, meat, poultry, cheese, fish, and the like, in an acceptable market condition. In another embodiment, the preheating is conducted by a gyrotron microwave beam. It is accomplishing by irradiating the product with a beam power density lower than 500 W per square cm. In another embodiment, convection heat source, is used to preheat the product. The source can comprise combustible gases, combustible fluids or hot air, in fact, in a standard tunnel furnace.

In one embodiment, the product is poultry and the decontamination surface is its skin. The microbes, viruses, parasites, and things are usually on the skin surface and/or hidden in the holes from a lost feather. In this embodiment, the beam power density and irradiation time are selected to heat the skin to a temperature that is sufficient for microbial inactivation on the skin surface and inside the hole(s). A preferable application is for poultry decontamination where the product surface (skin) is heated to a higher temperature

In another embodiment, the irradiation time is selected to be less than about 100 milliseconds. Selecting a radiation time of less than about 100 milliseconds can avoid a Maillard reaction on organic products.

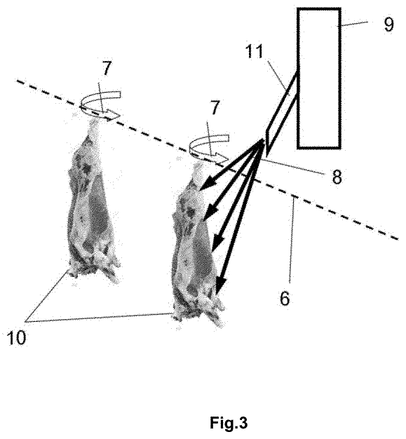

In another embodiment, the products are placed on a transporter 6 as shown in FIG. 3 that creates a flow of the product and sufficiently changes the product's spatial orientation (7) with respect to the beam (8) generated with the gyrotron (9) to provide an irradiation of the entire surface of the product (10). In this embodiment, the products can be meat carcasses. This is realized through spinning of each individual product, or turning them over, or changing the shape of the microwave beam corresponding to the product configuration by optics (11).

### EXAMPLES

The following examples are presented to provide a more detailed explanation of the present method and of preferred embodiments, but are intended as illustrations and not limitations.

### Example 1

Meat samples were allowed to spoil at room temperature for 24 hours. After the meat had fouled, washings from the surfaces were collected in 10 mL sterile water, and the bacterial population counted by plating serial dilutions on Tryptic Soy Agar medium. A cell count of 1×10⁶ CFU/20 μl was delivered on the surface of the meat pieces pre-moistened with distilled water as droplets of 20 μl, and each droplet laid meat piece was immediately swabbed with sterile cotton swabs before and after exposure to varying levels of the microwave beams.

Testing was conducted in GTI's gyrotron demonstration installation. A 15 kW gyrotron working at 86 GHz was used. The original circle beam was focused to the area of around 20 sq cm by the applicator (7), which consisted of metal mirrors capable of changing the beam diameter.

There were two incident microwave powers: 5 kW, and 10 kW providing accordingly area power density around 250 W/cm² and 500 W/cm². The exposure time in each test was 0.5 sec.

The swabbed samples were suspended in sterile 1 ml sterile water and the bacterial populations determined by standard dilution plating on Tryptic Soy agar incubated at 35° C. for 24 hours for growth. The bacterial recovery after gyrotron beam exposure was compared to unexposed meat. It was calculated that there was a greater 5 Log-reduction in bacteria after the treatments (or 99.999% of bacteria were killed) by the gyrotron beam with an area power density around 500 W per sq cm.

### Example 2

Meat fat and lean samples were inoculated with surrogate cultures both as a broth preparation and in the context of a fecal slurry preparation. Cattle fecal material collected from a meat processing facility was formed into a slurry. The material strained through a cheesecloth filter to remove the larger particles. The remaining liquid material combined 1:1 with a cocktail of the stock cultures.

Both these combinations and the broth preparations were used to surface inoculate beef samples. A 0.1 mL volume of a preparation spread over the surface of the upper surface samples, avoiding the edges of the sample to prevent inoculums from dripping over the sides. An additional set of pieces of each type of product remained uninoculated.

Testing was conducted in GTI's gyrotron demonstration installation. As a microwave source, a 50 kW gyrotron working at 60 GHz was used. The circle beam was focused to the area of around 20 sq. cm. The power densities over samples changed from 1,000 W per sq cm to 2,000 W per sq cm and the exposure time—from 0.2 sec to 0.08 sec.

Processed samples plated onto MacConkey Agar (MAC, Neogen) as well as KF Streptococcus Agar (KFS, Neogen) to recover the E. coli and E. faecium cultures. MAC and KFS plates were incubated at about 35° C.

After incubation, samples were enumerated by hand using a Quebec colony counter (Model #3325, Reichert Technologies, and Depew, N.Y.). Uninoculated control samples also were evaluated for the background presence of each organism. Bacterial counts were converted to log₁₀ before calculating average counts or subtracting one count from another. On average, the microwave beam treatments resulted in a greater than 5 log reduction in E. coli or 99.9995% were killed.

A visual and instrumental assessment of the samples suggested that there was no significant difference in the appearance of treated and untreated pieces.

Unless otherwise indicated, all numbers expressing quantities of treatment conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A method for decontamination/sterilization of solid and semisolid food products comprising:
a) providing a solid or semisolid food product having a liquid or liquefiable layer on the product surface; and
b) irradiating at least a portion of the entire product surface with a gyrotron microwave beam having a power density of at least about 500 W per square cm, with the frequency of the beam selected to be sufficient for the beam penetration depth to be approximately equal to or less than the liquid or liquefiable material layer thickness, and with an irradiation time of no more than about 0.5 second to thereby remove the liquid or liquefiable layer on the product surface by explosive vaporization and eliminating or killing greater than 99% of bacteria, viruses, and parasites on the product surface while avoiding a negative impact on the product surface.

2. (canceled)

3. The method of claim 1 wherein the food product is selected from the group consisting of meat, poultry, seafood, produce, dairy products, and mixtures thereof.

4. The method of claim 3, wherein the food product is packaged in material having an absorption of the gyrotron microwave beam lower than the liquid or liquefiable layer on the product surface.

5. The method of claim 1, wherein a liquid layer is on the surface of the product and the liquid is water, salted water, oil, blood, or a combination thereof.

6. The method of claim 1, wherein a liquefiable layer is on the surface of the product and the liquifiable layer is fat, wax, sap, or a combination thereof.

7. The method of claim 1, further comprising irradiating the product with the gyrotron microwave beam more than once.

8. The method of claim 1, comprising irradiating the entire product surface.

9. The method of claim 1, further comprising focusing the beam by optics to correspond to the shape of the product.

10. The method of claim 1, further comprising placing the product on a transporter that moves the product to change the spatial orientation of the product with respect to the beam to irradiate the entire surface of the product.

11. The method of claim 1, wherein the gyrotron microwave beam frequency is about 40 GHz to about 200 GHz.

12. The method of claim 1, wherein the irradiation time is about 0.5 seconds to about 0.01 seconds.

13. The method of claim 1, wherein the power density is about 500 W per square cm to about 5000 W per square cm.

14. The method of claim 1, wherein a naturally existing liquid or liquefiable material on the product surface is the liquid or liquefiable layer.

15. The method of claim 1, further comprising applying a liquid or liquefiable layer to the product surface to provide the product having a liquid or liquefiable layer on the product surface.

16. The method of claim 7, further comprising applying a liquid or liquefiable material to the product surface before each irradiation.

17. The method of claim 1, further comprising applying liquid or liquefiable material to the product surface after irradiation.

18. The method of claim 16, further comprising applying liquid or liquefiable material to the product surface after a final irradiation.

19. The method of claim 1, wherein the product is poultry and the product surface is poultry skin.

20. (canceled)

21. (canceled)

22. The method of claim 1, wherein the irradiation time is less than about 100 milliseconds and the power density of the beam is selected such that the selected power density of the beam prevents Maillard reaction of the organic product.

23. (canceled)
